(19) United States
(12) Patent Application Publication
(10) Pub. No.: US 2017/0115812 A1
(43) Pub. Date: Apr. 27, 2017

(54) CAPACITIVE FORCE SENSING TOUCH PANEL

(71) Applicant: Raydium Semiconductor Corporation, Hsinchu (TW)

(72) Inventors: Yi-Ying Lin, Hualien City (TW); Hsin-Wei Shieh, New Taipei City (TW); Chang-Ching Chiang, Taichung City (TW); Kun-Pei Lee, Zhunan Township (TW)

(21) Appl. No.: 15/334,539

(22) Filed: Oct. 26, 2016

Related U.S. Application Data
(60) Provisional application No. 62/246,174, filed on Oct. 26, 2015.
(60) Provisional application No. 62/256,177, filed on Nov. 17, 2015.

(51) Int. Cl. G06F 3/041; G02F 1/1333; G02F 1/1368; G06F 3/044

(52) U.S. Cl. CPC G06F 3/0416; G06F 3/044; G06F 3/0412; G02F 1/13338; G02F 1/1368; G06F 2203/04107; G06F 2203/04112; G02F 2001/13685

(57) ABSTRACT

A capacitive force sensing touch panel is disclosed. The capacitive force sensing touch panel includes pixels. A laminated structure of each pixel includes a first substrate, a TFT layer, a first conductive layer, a second conductive layer, a third conductive layer and a second substrate. The TFT layer is disposed above the first substrate. The first conductive layer is disposed above the TFT layer. The second conductive layer is disposed above the first conductive layer. The third conductive layer corresponds to the second conductive layer and the third conductive layer is disposed above the second conductive layer. The second substrate is disposed above the third conductive layer.

### BACKGROUND OF THE INVENTION

1. Field of the Invention

This invention relates to touch panel, especially to a capacitive force sensing touch panel.

2. Description of the Prior Art

In general, if capacitive touch electrodes in a capacitive touch panel are also used to be force sensing electrodes at the same time, such as the sensing electrode SG in FIG. 1 is disposed on the upper substrate 12. And, the reference electrode RE can be disposed on the lower substrate 10 in FIG. 1.

When the upper substrate 12 is pressed by a finger, because the distance d between the sensing electrode SE on the upper substrate 12 and the reference electrode RE on the lower substrate 10 will be changed based on different forces provided by the finger, the capacitance sensed between the sensing electrode SE and the reference electrode RE will be also changed accordingly.

However, the capacitive touch sensing signal will be also changed based on different finger pressing areas. When the finger press the touch panel downward, the finger pressing area will be increased and the sensed capacitance will be also changed accordingly. Therefore, the force sensing determined according to capacitance variation will be also affected and no accurate force sensing result can be obtained by using the conventional laminated structure of capacitive touch panel shown in FIG. 1.

### SUMMARY OF THE INVENTION

Therefore, the invention provides a capacitive force sensing touch panel to solve the above-mentioned problems.

An embodiment of the invention is a capacitive force sensing touch panel. In this embodiment, the capacitive force sensing touch panel includes pixels. A laminated structure of each pixel includes a first substrate, a TFT layer, a first conductive layer, a second conductive layer, a third conductive layer and a second substrate. The TFT layer is disposed above the first substrate. The first conductive layer is disposed above the TFT layer. The second conductive layer is disposed above the first conductive layer. The third conductive layer corresponds to the second conductive layer and the third conductive layer is disposed above the second conductive layer. The second substrate is disposed above the third conductive layer.

In an embodiment, the capacitive force sensing touch panel includes an in-cell touch panel structure.

In an embodiment, the laminated structure further includes a common electrode electrically connected to the first conductive layer and divided to form at least one touch electrode through disconnection or electrical connection.

In an embodiment, the common electrode is disposed between the TFT layer and the first conductive layer; the first conductive layer and the common electrode are electrically connected through a via.

In an embodiment, the common electrode is disposed between the first conductive layer and the second conductive layer; the first conductive layer and the common electrode are electrically connected through a via.

In an embodiment, during a touch sensing period, the first conductive is driven as a touch electrode to perform a node self-capacitive touch sensing.

In an embodiment, the entire second conductive layer is configured as a force sensing electrode; during a force sensing period, the force sensing electrode receives a force sensing signal and senses a capacitance variation between the third conductive layer and the second conductive layer caused by a change of a distance between the third conductive layer and the second conductive layer; during a touch sensing period, the force sensing electrode receives a floating level.

In an embodiment, a part of the second conductive layer is configured as a force sensing electrode, and at least a part of the other part of the second conductive layer is configured as a dummy electrode; during a force sensing period, the force sensing electrode receives a force sensing signal and senses a capacitance variation between the third conductive layer and the second conductive layer caused by a change of a distance between the third conductive layer and the second conductive layer and the dummy electrode receives a floating level; during a touch sensing period, the force sensing electrode and the dummy electrode both receive the floating level.

In an embodiment, a part of the second conductive layer is configured as a force sensing electrode, and at least a part of the other part of the second conductive layer is configured as touch electrode traces; during a force sensing period, the force sensing electrode receives a force sensing signal and senses a capacitance variation between the third conductive layer and the second conductive layer caused by a change of a distance between the third conductive layer and the second conductive layer and the dummy electrode receives a floating level; during a touch sensing period, the force sensing electrode receives a floating level.

In an embodiment, the third conductive layer disposed above the second conductive layer is formed by an arbitrary conductive layer and maintained at a fixed voltage, when the laminated structure is pressed by a force, the third conductive layer is used as a shielding electrode of the second conductive layer; the fixed voltage is a reference voltage or ground.

In an embodiment, the second conductive layer has a mesh type and the second conductive layer is divided to form at least one force sensing electrode through disconnection or electrical connection.

In an embodiment, the at least one force sensing electrode is electrically connected to form a force sensing electrode set depending on layout and operational requirements.

In an embodiment, a touch sensing mode and a force sensing mode of the capacitive force sensing touch panel are driven in a time-sharing way with a display mode of the capacitive force sensing touch panel; the capacitive force sensing touch panel is operated in the touch sensing mode during a blanking interval of a display period and the first conductive layer is driven as a touch electrode.

In an embodiment, the blanking interval includes at least one of a vertical blanking interval (VBI), a horizontal blanking interval (HBI), and a long horizontal blanking interval, the long horizontal blanking interval has a time length equal to or larger than that of the horizontal blanking interval, the long horizontal blanking interval is obtained by redistributing a plurality of the horizontal blanking interval or the long horizontal blanking interval includes the vertical blanking interval.

Another embodiment of the invention is also a capacitive force sensing touch panel. In this embodiment, the capacitive force sensing touch panel includes pixels. A laminated structure of each pixel includes a first substrate, a TFT layer, a first conductive layer, a second conductive layer and a second substrate. The TFT layer is disposed above the first substrate. The first conductive layer is disposed above the TFT layer. The second conductive layer corresponds to the first conductive layer and the second conductive layer is disposed above the first conductive layer. The second substrate is disposed above the second conductive layer.

In an embodiment, the capacitive force sensing touch panel includes an in-cell touch panel structure.

In an embodiment, the first conductive layer has a mesh type or a strip type.

In an embodiment, the laminated structure further includes a common electrode electrically connected to the first conductive layer and divided to form at least one touch electrode through disconnection or electrical connection.

In an embodiment, the common electrode is disposed between the TFT layer and the first conductive layer; the first conductive layer and the common electrode are electrically connected through a via.

In an embodiment, the common electrode is disposed between the first conductive layer and the second conductive layer; the first conductive layer and the common electrode are electrically connected through a via.

In an embodiment, at least one force sensing electrode and force sensing electrode traces are formed by the first conductive layer in a region out of touch electrode traces.

In an embodiment, at least one dummy electrode is formed by the first conductive layer in a region out of the touch electrode traces and the force sensing electrode traces.

In an embodiment, the at least one dummy electrode is not electrically connected with the at least one touch electrode or the at least one force sensing electrode to maintain a visibility of the capacitive force sensing touch panel and the at least one dummy electrode receives a floating level.

In an embodiment, the common electrode is not disposed above the at least one force sensing electrode to avoid shielding an electrical field of force sensing.

In an embodiment, the at least one force sensing electrode and the at least one touch electrode are at least partially overlapped.

In an embodiment, a touch sensing mode and a force sensing mode of the capacitive force sensing touch panel are driven in a time-sharing way with a display mode of the capacitive force sensing touch panel; the capacitive force sensing touch panel is operated in the touch sensing mode during a blanking interval of a display period.

In an embodiment, the blanking interval includes at least one of a vertical blanking interval (VBI), a horizontal blanking interval (HBI), and a long horizontal blanking interval, the long horizontal blanking interval has a time length equal to or larger than that of the horizontal blanking interval, the long horizontal blanking interval is obtained by redistributing a plurality of the horizontal blanking interval or the long horizontal blanking interval includes the vertical blanking interval.

In an embodiment, during a touch sensing period, the at least one force sensing electrode is maintained at a fixed voltage which is a reference voltage or ground.

In an embodiment, during a force sensing period, the at least one touch electrode is maintained at a fixed voltage which is a reference voltage or ground.

In an embodiment, a touch sensing mode and a force sensing mode of the capacitive force sensing touch panel are driven in the same amplitude, the same phase or the same frequency to reduce a driving loading of the touch sensing mode and the force sensing mode without reducing touch and force sensing times.

In an embodiment, a touch sensing period and a display period of the capacitive force sensing touch panel are at least partially overlapped.

In an embodiment, a force sensing period and a display period of the capacitive force sensing touch panel are at least partially overlapped.

Compared to the prior art, the capacitive force sensing touch panel of the invention has the following advantages and effects:

(1) Although touch sensing and force sensing both use capacitance variation as judgment basis, the invention uses a relative upper electrode to avoid the effects caused by the change of finger pressing area to maintain the accurate sensed capacitance during the force sensing period.

(2) The capacitive force sensing touch panel of the invention can be applied to in-cell touch panel structure to achieve the effects of thinner and lighter.

(3) Touch sensing and force sensing of the capacitive force sensing touch panel of the invention can be driven in a time-sharing way and operated during the blanking interval of the display period to avoid the noise interference of the liquid crystal module.

The advantage and spirit of the invention may be understood by the following detailed descriptions together with the appended drawings.

### BRIEF DESCRIPTION OF THE APPENDED DRAWINGS

FIG. 1 illustrates a schematic diagram of the sensing electrode and the reference electrode in conventional capacitive touch panel.

FIG. 2A and FIG. 2B illustrate schematic diagrams of the entire laminated structure and the unit electrode in the laminated structure of the node self-capacitive force sensing touch panel respectively in an embodiment of the invention.

FIG. 3 illustrates a cross-sectional schematic diagram of the force sensing laminated structure in an embodiment of the invention.

FIG. 4 illustrates a cross-sectional schematic diagram of the touch sensing laminated structure in an embodiment of the invention.

FIG. 5 illustrates a cross-sectional schematic diagram of the common electrode disposed under the first conductive layer and the via electrically connecting the first conductive layer and the common electrode.

FIG. 6 illustrates a cross-sectional schematic diagram of the common electrode disposed above the first conductive layer and the via electrically connecting the first conductive layer and the common electrode.

FIG. 7 illustrates a schematic diagram of the second conductive layer divided to form force sensing electrodes through disconnection or electrical connection and the force sensing electrodes electrically connected to form a force sensing electrode set depending on layout and operational requirements.

FIG. 8A and FIG. 8B illustrate schematic diagrams of the entire laminated structure and the unit electrode in the laminated structure of the node self-capacitive force sensing touch panel respectively in another embodiment of the invention.

FIG. 9 illustrates a cross-sectional schematic diagram of the common electrode disposed under the first conductive layer and the via electrically connecting the first conductive layer and the common electrode.

FIG. 10 illustrates a cross-sectional schematic diagram of the common electrode disposed above the first conductive layer and the via electrically connecting the first conductive layer and the common electrode.

FIG. 11 illustrates a schematic diagram of the first conductive layer forming the force sensing electrodes having strip type and their traces in the region out of the touch electrode traces.

FIG. 12 illustrates an enlarged schematic diagram of the range in the dashed circle of FIG. 11.

FIG. 13 illustrates a schematic diagram of the first conductive layer forming the force sensing electrodes having mesh type and their traces in the region out of the touch electrode traces.

FIG. 14 illustrates an enlarged schematic diagram of the range in the dashed circle of FIG. 13.

FIG. 15 illustrates a schematic diagram of the force sensing electrode overlapping multiple touch electrodes.

FIG. 16 illustrates a timing diagram of the capacitive force sensing touch panel performing touch sensing and force sensing during the blanking interval of the display period of the capacitive force sensing touch panel.

FIG. 17˜FIG. 20 illustrate timing diagrams of the touch sensing driving and force sensing driving of the capacitive force sensing touch panel in different embodiments respectively.

FIG. 21 illustrates a schematic diagram of the blanking interval including a vertical blanking interval (VBI), a horizontal blanking interval (HBI) and a long horizontal blanking interval.

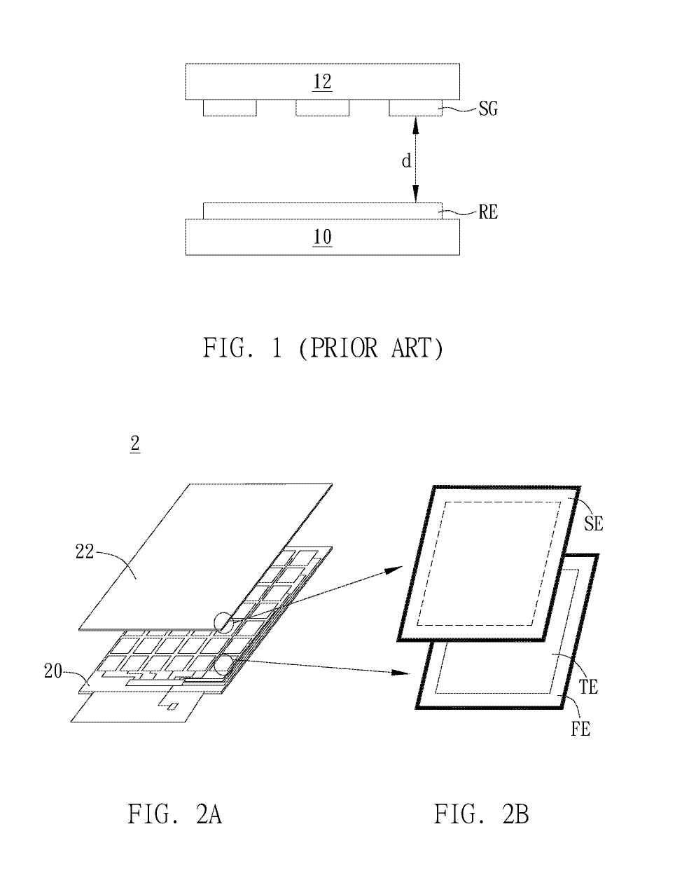

### DETAILED DESCRIPTION OF THE INVENTION

The invention discloses a capacitive force sensing touch panel which can have an in-cell touch panel structure and use a relative upper shielding electrode to avoid the effects caused by the change of finger pressing area to maintain the accurate sensed capacitance during the force sensing period to improve the drawbacks of the prior arts.

At first, please refer to FIG. 2A and FIG. 2B. FIG. 2A and FIG. 2B illustrate schematic diagrams of the entire laminated structure and the unit electrode in the laminated structure of the node self-capacitive force sensing touch panel respectively in an embodiment of the invention.

As shown in FIG. 2A and FIG. 2B, the laminated structure 2 includes a first substrate 20 and a second substrate 22, and the second substrate 22 is disposed above the first substrate 20. In fact, the first substrate 20 and the second substrate 22 can be a TFT glass and a color filter glass respectively, but not limited to this.

In this embodiment, a shielding electrode SE is disposed on a lower surface of the second substrate 22; a touch sensing electrode TE and a force sensing electrode FE are disposed on an upper surface of the first substrate 20. It should be noticed that the position of the shielding electrode SE disposed on the lower surface of the second substrate 22 corresponds to the position of the force sensing electrode FE disposed on the upper surface of the first substrate 20 to achieve the shielding effect. In fact, the shielding electrode SE can be formed by an arbitrary conductive layer and maintained at a fixed voltage, such as a reference voltage or ground. When the laminated structure 2 is pressed by a force, the shielding electrode SE can be used as a shielding electrode of the lower force sensing electrode FE to achieve the shielding effect.

Then, please refer to FIG. 3. FIG. 3 illustrates a cross-sectional schematic diagram of the force sensing laminated structure in an embodiment of the invention. As shown in FIG. 3, the force sensing laminated structure 3 includes a polarizing layer 30, a TFT glass layer 31, a common electrode 32, a force sensing electrode FE, a liquid crystal layer 33, a shielding electrode SE, a black matrix layer BM, a color filter glass layer 34, a polarizing layer 35, an OCA layer 36 and a cover lens layer 37. Wherein, the force sensing electrode FE is disposed at intervals above the common electrode 32; the shielding electrode SE is disposed at intervals under the black matrix layer BM, and the position of the shielding electrode SE should correspond to the position of the lower force sensing electrode FE to achieve the shielding effect.

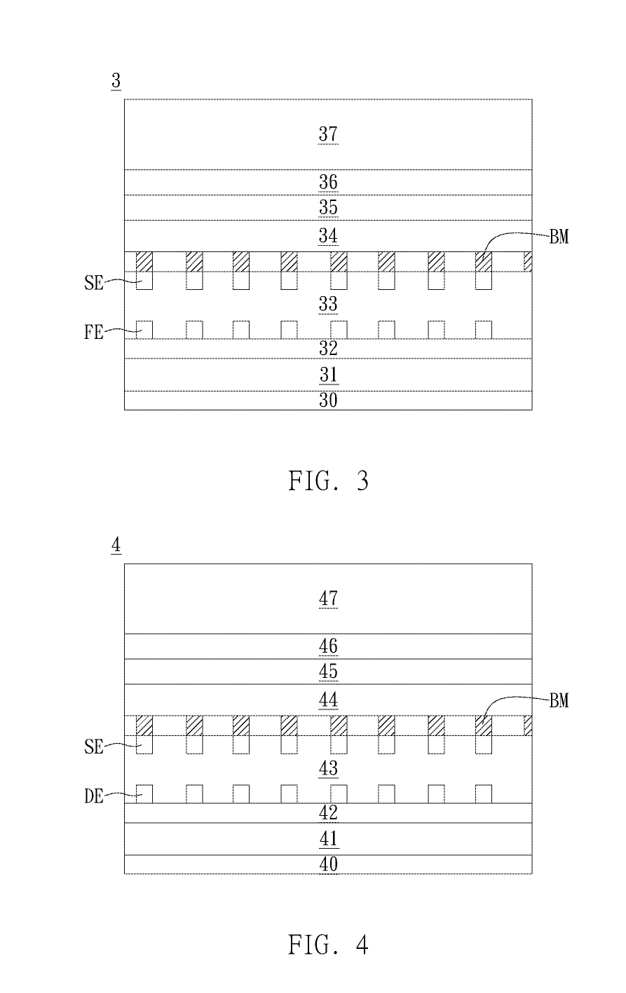

Please also refer to FIG. 4. FIG. 4 illustrates a cross-sectional schematic diagram of the touch sensing laminated structure in an embodiment of the invention. As shown in FIG. 4, the touch sensing laminated structure 4 includes a polarizing layer 40, a TFT glass layer 41, a common electrode (the touch electrode) 42, a dummy electrode DE, a liquid crystal layer 43, a shielding electrode SE, a black matrix layer BM, a color filter glass layer 44, a polarizing layer 45, an OCA layer 46 and a cover lens layer 47. Wherein, the common electrode 42 is used as the touch electrode; the dummy electrode DE is disposed at intervals above the common electrode 42; the shielding electrode SE is disposed at intervals under the black matrix layer BM, and the position of the shielding electrode SE should correspond to the position of the lower dummy electrode DE.

Next, different embodiments will be used to introduce different laminated structures of the pixel of the capacitive force sensing touch panel of the invention.

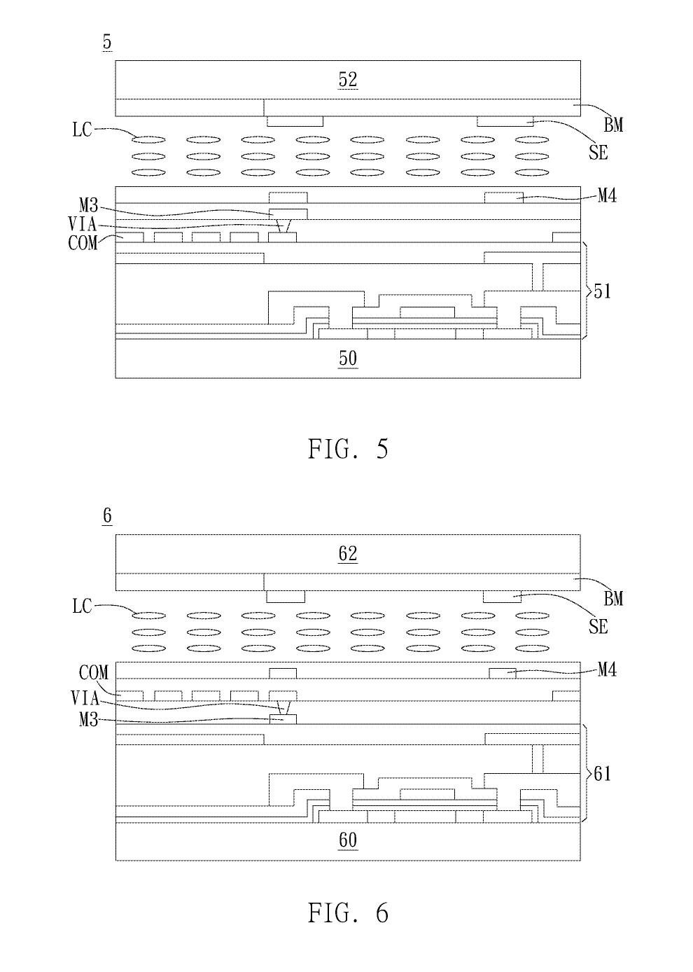

Please refer to FIG. 5. FIG. 5 illustrates a cross-sectional schematic diagram of the common electrode disposed under the first conductive layer and the via electrically connecting the first conductive layer and the common electrode. As shown in FIG. 5, the laminated structure 5 includes a first substrate 50, a TFT layer 51, a common electrode COM, a first conductive layer M3, a second conductive layer M4, a liquid crystal layer LC, a shielding electrode SE, a black matrix layer BM and a second substrate 52. Wherein, the TFT layer 51 is disposed above the first substrate 50. The common electrode COM is disposed above the TFT layer 51. The first conductive layer M3 is disposed above the common electrode COM. The second conductive layer M4 is disposed above the first conductive layer M3. The shielding electrode SE corresponds to the second conductive layer M4 and disposed above the second conductive layer M4. The black matrix layer BM is disposed above the shielding electrode SE. The second substrate 52 is disposed above the black matrix layer BM.

It should be noticed that in the laminated structure 5 of FIG. 5, the common electrode COM is disposed under the first conductive layer M3 and the first conductive layer M3 and the common electrode COM are electrically connected through the via VIA. During the touch sensing period, the first conductive layer M3 electrically connected to the common electrode COM is driven as a touch electrode to perform node self-capacitive touch sensing; at this time, the second conductive layer M4 is maintained at a fixed voltage, such as a reference voltage or ground, but not limited to this. During the force sensing period, the second conductive layer M4 disposed under the shielding electrode SE is driven as a force sensing electrode to receive a force sensing signal and sense a capacitance variation between the shielding electrode SE and the second conductive layer M4 caused by a change of a distance between the shielding electrode SE and the second conductive layer M4; at this time, the first conductive layer M3 electrically connected to the common electrode COM is maintained at a fixed voltage, such as a reference voltage or ground, but not limited to this.

Please refer to FIG. 6. FIG. 6 illustrates a cross-sectional schematic diagram of the common electrode disposed above the first conductive layer and the via electrically connecting the first conductive layer and the common electrode. As shown in FIG. 6, the laminated structure 6 includes a first substrate 60, a TFT layer 61, a first conductive layer M3, a common electrode COM, a second conductive layer M4, a liquid crystal layer LC, a shielding electrode SE, a black matrix layer BM and a second substrate 62. Wherein, the TFT layer 61 is disposed above the first substrate 60. The first conductive layer M3 is disposed above the TFT layer 61. The common electrode COM is disposed above the first conductive layer M3. The second conductive layer M4 is disposed above the common electrode COM. The shielding electrode SE corresponds to the second conductive layer M4 and disposed above the second conductive layer M4. The black matrix layer BM is disposed above the shielding electrode SE. The second substrate 62 is disposed above the black matrix layer BM.

It should be noticed that in the laminated structure 6 of FIG. 6, the common electrode COM is disposed above the first conductive layer M3 and the first conductive layer M3 and the common electrode COM are electrically connected through the via VIA. During the touch sensing period, the first conductive layer M3 electrically connected to the common electrode COM is driven as a touch electrode to perform node self-capacitive touch sensing; at this time, the second conductive layer M4 is maintained at a fixed voltage, such as a reference voltage or ground, but not limited to this. During the force sensing period, the second conductive layer M4 disposed under the shielding electrode SE is driven as a force sensing electrode to receive a force sensing signal and sense a capacitance variation between the shielding electrode SE and the second conductive layer M4 caused by a change of a distance between the shielding electrode SE and the second conductive layer M4; at this time, the first conductive layer M3 electrically connected to the common electrode COM is maintained at a fixed voltage, such as a reference voltage or ground, but not limited to this.

In practical applications, it can be that the entire second conductive layer M4 is configured as the force sensing electrode FE or only a part of the second conductive layer M4 is configured as the force sensing electrode FE depending on practical needs.

When the entire second conductive layer M4 is configured as the force sensing electrode FE, during the force sensing period, the force sensing electrode FE will receive a force sensing signal and sense a capacitance variation between the shielding electrode SE and the second conductive layer M4 caused by a change of a distance between the shielding electrode SE and the second conductive layer M4; during the touch sensing period, the force sensing electrode FE will receive a floating level.

When only a part of the second conductive layer M4 is configured as the force sensing electrode FE, if at least a part of the other part of the second conductive layer M4 is configured as a dummy electrode DE, during the force sensing period, the force sensing electrode FE will receive a force sensing signal and sense a capacitance variation between the shielding electrode SE and the second conductive layer M4 caused by a change of a distance between the shielding electrode SE and the second conductive layer M4, and the dummy electrode DE will receive a floating level; during the touch sensing period, the force sensing electrode FE and the dummy electrode DE will both receive the floating level.

When only a part of the second conductive layer M4 is configured as the force sensing electrode FE, if at least a part of the other part of the second conductive layer M4 is configured as touch electrode traces; during the force sensing period, the force sensing electrode FE will receive a force sensing signal and sense a capacitance variation between the shielding electrode SE and the second conductive layer M4 caused by a change of a distance between the shielding electrode SE and the second conductive layer M4, and the dummy electrode DE will receive a floating level; during the touch sensing period, the force sensing electrode FE will receive the floating level.

Then, please refer to FIG. 7. As shown in FIG. 7, the second conductive layer M4 can be divided to form different force sensing electrodes FE through disconnection or electrical connection. And, the different force sensing electrodes FE can be electrically connected to form a force sensing electrode set depending on layout and operational requirements. The common electrode COM can be divided to form different touch sensing electrodes TE through disconnection or electrical connection. In this embodiment, the force sensing electrode traces FR are formed by the second conductive layer M4 and the touch electrode traces TR are formed by the first conductive layer M3, wherein the touch electrode traces TR and the common electrode COM are electrically connected through the via VIA, and six force sensing electrodes are electrically connected to form a force sensing electrode set.

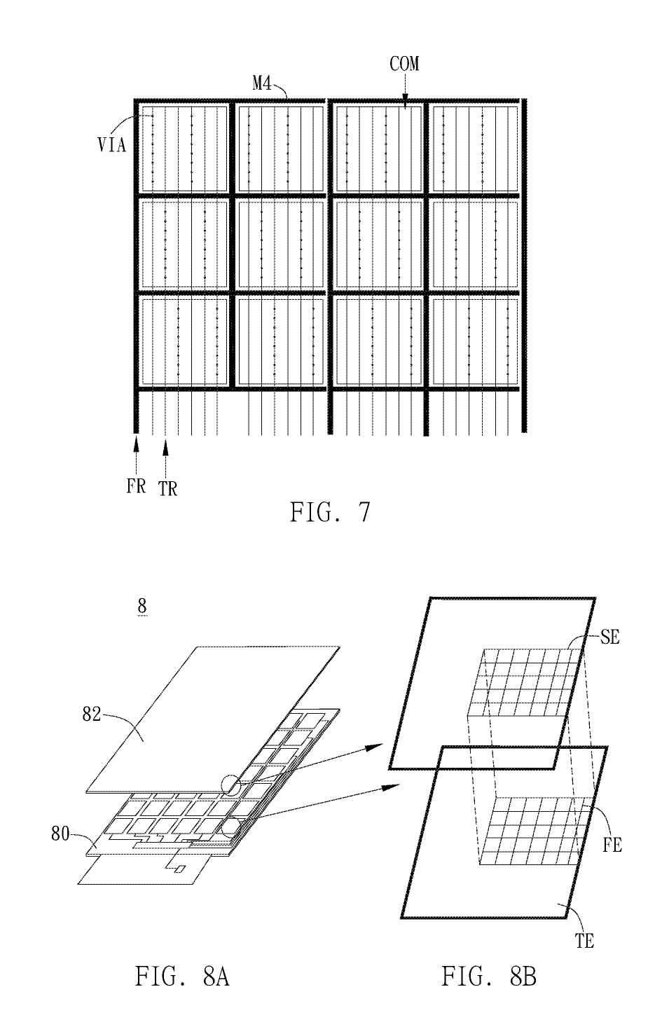

Then, please refer to FIG. 8A and FIG. 8B. FIG. 8A and FIG. 8B illustrate schematic diagrams of the entire laminated structure and the unit electrode in the laminated structure of the node self-capacitive force sensing touch panel respectively in another embodiment of the invention.

As shown in FIG. 8A and FIG. 8B, the laminated structure 8 includes a first substrate 80 and a second substrate 82, and the second substrate 82 is disposed above the first substrate 80. In fact, the first substrate 80 and the second substrate 82 can be a TFT glass and a CF glass respectively, but not limited to this.

In this embodiment, a shielding electrode SE is disposed on a lower surface of the second substrate 82; a touch sensing electrode TE and a force sensing electrode FE are disposed on an upper surface of the first substrate 80. It should be noticed that the position of the shielding electrode SE disposed on the lower surface of the second substrate 82 corresponds to the position of the force sensing electrode FE disposed on the upper surface of the first substrate 80 to achieve the shielding effect.

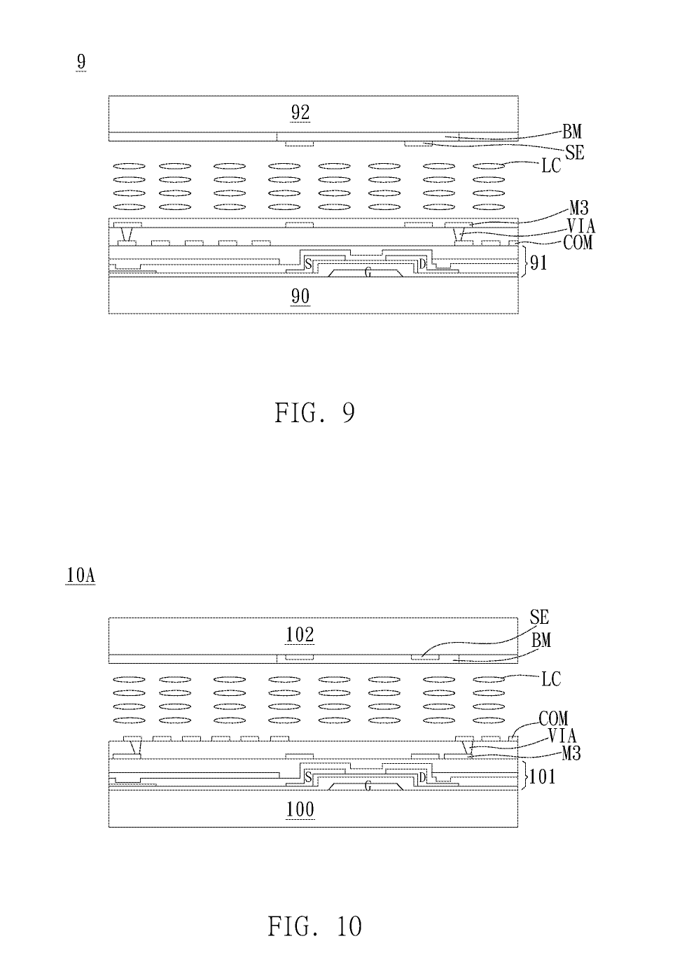

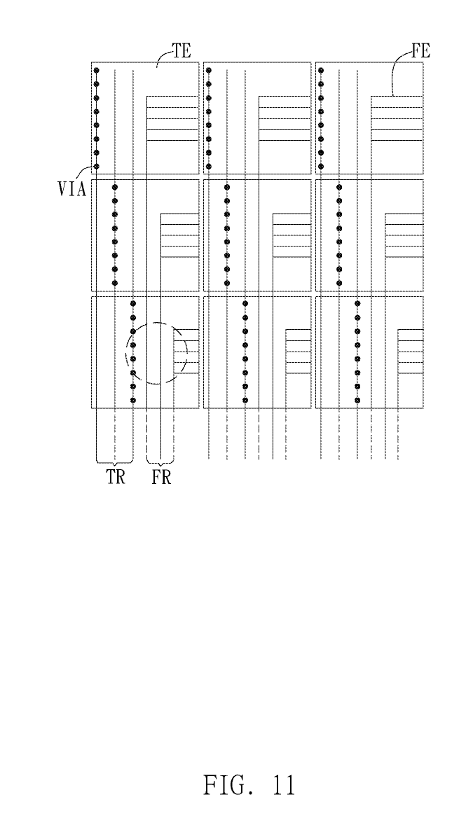

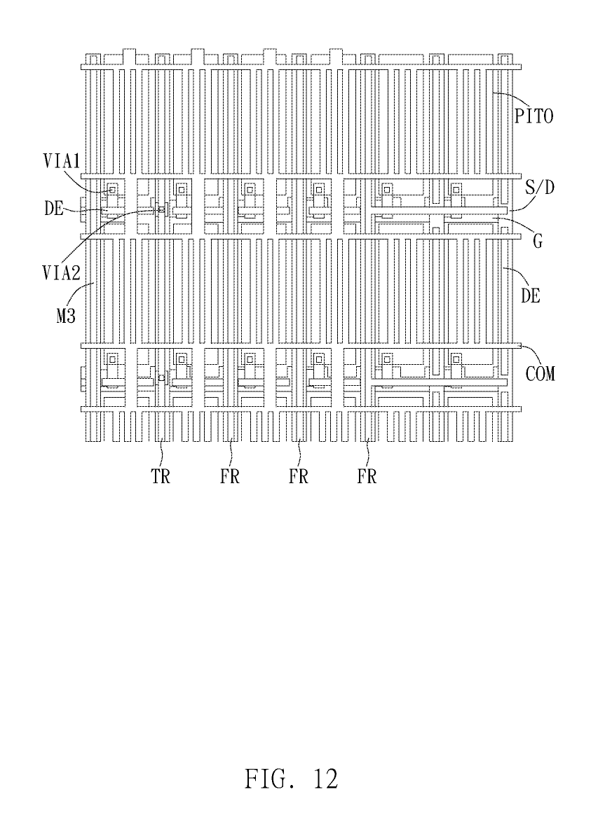

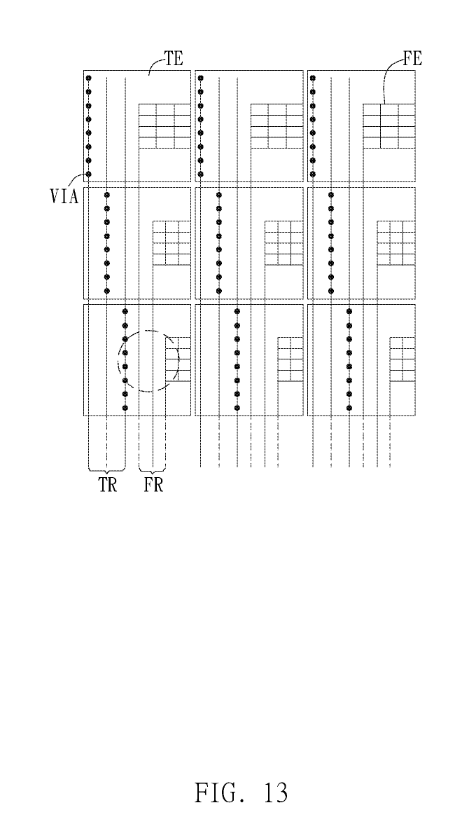

Then, please refer to FIG. 9. FIG. 9 illustrates a cross-sectional schematic diagram of the common electrode disposed under the first conductive layer and the via electrically connecting the first conductive layer and the common electrode. As shown in FIG. 9, the laminated structure 9 includes a first substrate 90, a TFT layer 91, a common electrode COM, a first conductive layer M3, a liquid crystal layer LC, a shielding electrode SE, a black matrix layer BM and a second substrate 92. Wherein, the TFT layer 91 is disposed above the first substrate 90. The common electrode COM is disposed above the TFT layer 91. The first conductive layer M3 is disposed above the common electrode COM. The shielding electrode SE corresponds to the first conductive layer M3 and disposed above the first conductive layer M3. The black matrix layer BM is disposed above the shielding electrode SE. The second substrate 92 is disposed above the black matrix layer BM.

It should be noticed that in the laminated structure 9 of FIG. 9, the common electrode COM configured at intervals is disposed under the first conductive layer M3 configured at intervals. Some of the first conductive layer M3 is electrically connected to the common electrode COM through the via VIA, but the other of the first conductive layer M3 is not electrically connected to the common electrode COM. Wherein, the first conductive layer M3 electrically connected to the common electrode COM is used as the touch electrode and the first conductive layer M3 not electrically connected to the common electrode COM is used as the force sensing electrode which is corresponding to the shielding electrode SE and disposed under the shielding electrode SE to achieve the shielding effect.

Please also refer to FIG. 10. FIG. 10 illustrates a cross-sectional schematic diagram of the common electrode disposed above the first conductive layer and the via electrically connecting the first conductive layer and the common electrode. As shown in FIG. 10, the laminated structure 10A includes a first substrate 100, a TFT layer 101, a first conductive layer M3, a common electrode COM, a liquid crystal layer LC, a black matrix layer BM, a shielding electrode SE and a second substrate 102. Wherein, the TFT layer 101 is disposed above the first substrate 100. The first conductive layer M3 is disposed above the TFT layer 101. The common electrode COM is disposed above the first conductive layer M3. The liquid crystal layer LC is disposed above the common electrode COM. The shielding electrode SE corresponds to the first conductive layer M3 and disposed above the first conductive layer M3. The shielding electrode SE is disposed in the black matrix layer BM. The second substrate 102 is disposed above the black matrix layer BM.

It should be noticed that in the laminated structure 10A of FIG. 10, the common electrode COM configured at intervals is disposed above the first conductive layer M3 configured at intervals. Some of the first conductive layer M3 is electrically connected to the common electrode COM through the via VIA, but the other of the first conductive layer M3 is not electrically connected to the common electrode COM. Wherein, the first conductive layer M3 electrically connected to the common electrode COM is used as the touch electrode and the first conductive layer M3 not electrically connected to the common electrode COM is used as the force sensing electrode which is corresponding to the shielding electrode SE and disposed under the shielding electrode SE to achieve the shielding effect.

Then, please refer to FIG. 11 and FIG. 12. FIG. 11 illustrates a schematic diagram of the first conductive layer forming the force sensing electrodes having strip type and their traces in the region out of the touch electrode traces; FIG. 12 illustrates an enlarged schematic diagram of the range in the dashed circle of FIG. 11.

As shown in FIG. 11, the common electrode COM is divided through disconnection or electrically connection to form the touch electrode TE. The touch electrode TE is electrically connected to the touch electrode traces TR through the via VIA. The first conductive layer M3 will form the force sensing electrode FE having a strip type and the force sensing electrode traces FR electrically connected to the force sensing electrode FE in the region out of the touch electrode traces TR.

As shown in FIG. 12, the common electrode COM disposed in the force sensing region can be connected in the horizontal direction. No common electrode COM is disposed above the force sensing electrode traces FR, so that the force sensing will not be affected by the common electrode COM. The drain electrode D and the pixel ITO layer PITO are electrically connected through the via VIA1. The common electrode COM and the first conductive layer M3 are electrically connected through the via VIA2. The first conductive layer M3 along the vertical direction or horizontal direction is disconnected and maintained in the floating state. In addition, the dummy electrode DE not connected to the touch sensing electrode and the force sensing electrode can be formed by the first conductive layer M3 in the region out of the force sensing electrode traces FR and touch electrode traces TR to maintain a visibility of the capacitive force sensing touch panel.

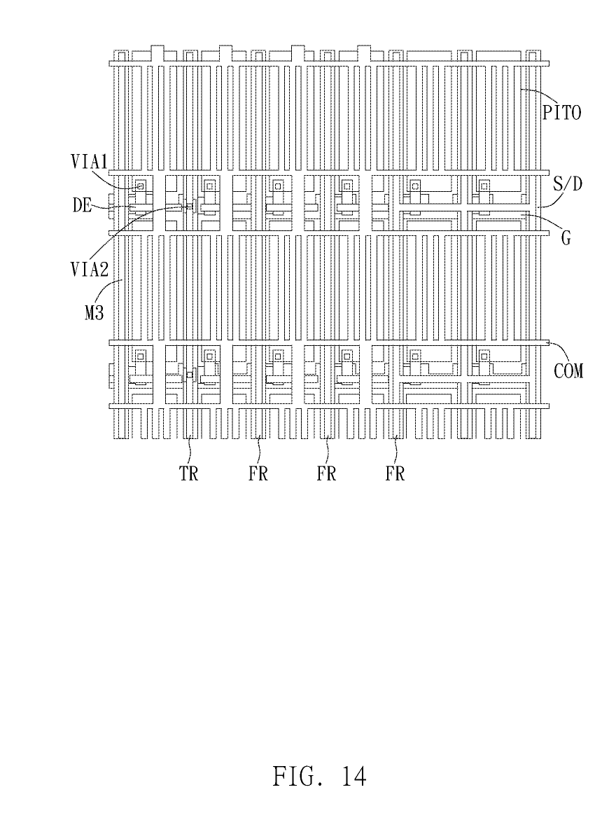

Please also refer to FIG. 13 and FIG. 14. FIG. 13 illustrates a schematic diagram of the first conductive layer forming the force sensing electrodes having mesh type and their traces in the region out of the touch electrode traces; FIG. 14 illustrates an enlarged schematic diagram of the range in the dashed circle of FIG. 13.

As shown in FIG. 13, the common electrode COM is divided through disconnection or electrically connection to form the touch electrode TE. The touch electrode TE is electrically connected to the touch electrode traces TR through the via VIA. The first conductive layer M3 will form the force sensing electrode FE having a mesh type and the force sensing electrode traces FR electrically connected to the force sensing electrode FE in the region out of the touch electrode traces TR.

It should be noticed that the force sensing electrode FE having the mesh type of FIG. 13 further includes the first conductive layer M3 connected in the vertical direction compared to the force sensing electrode FE having the strip type of FIG. 11; therefore, the sensitivity of force sensing can be further enhanced.

As shown in FIG. 14, the common electrode COM disposed in the force sensing region can be connected in the horizontal direction. No common electrode COM is disposed above the force sensing electrode traces FR, so that the force sensing will not be affected by the common electrode COM. The pixel ITO layer PITO and the drain electrode D are electrically connected through the via VIA1. The first conductive layer M3 and the common electrode COM are electrically connected through the via VIA2. The first conductive layer M3 along the vertical direction or horizontal direction is disconnected and maintained in the floating state. In addition, the dummy electrode DE not connected to the touch sensing electrode and the force sensing electrode can be formed by the first conductive layer M3 in the region out of the force sensing electrode traces FR and touch electrode traces TR to maintain a visibility of the capacitive force sensing touch panel.

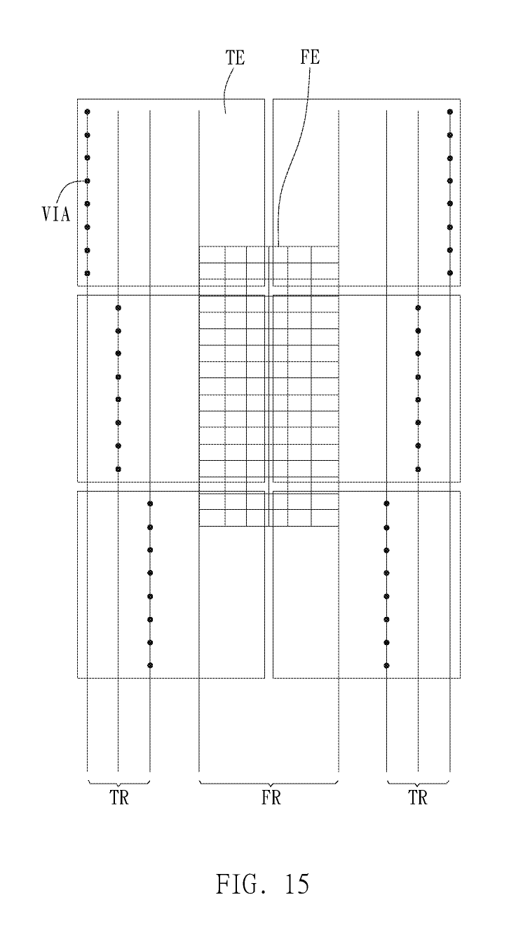

Please also refer to FIG. 15. As shown in FIG. 15, the force sensing electrode FE having the mesh type can overlap multiple touch electrodes TE. In this embodiment, the force sensing electrode FE having the mesh type partially overlaps six touch electrodes TE, but not limited to this.

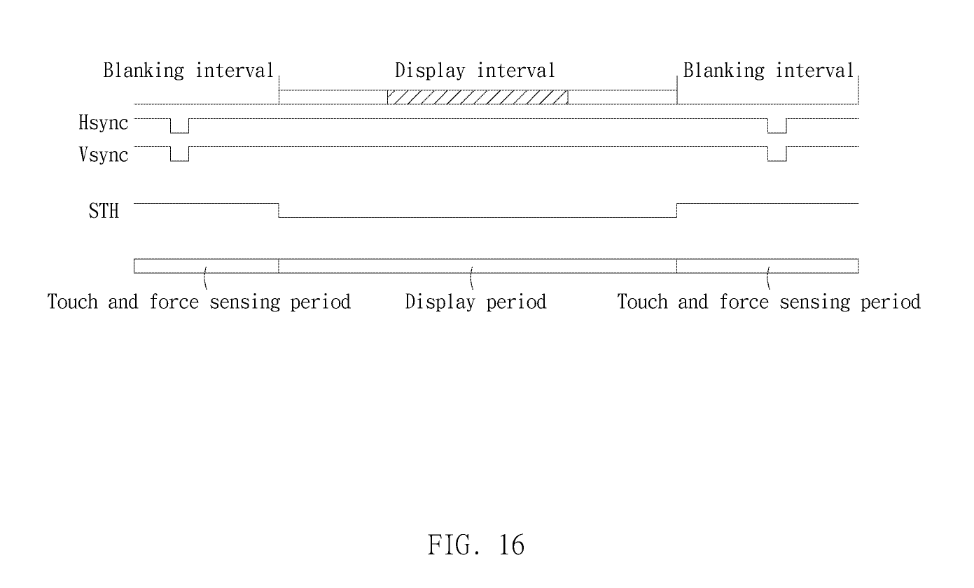

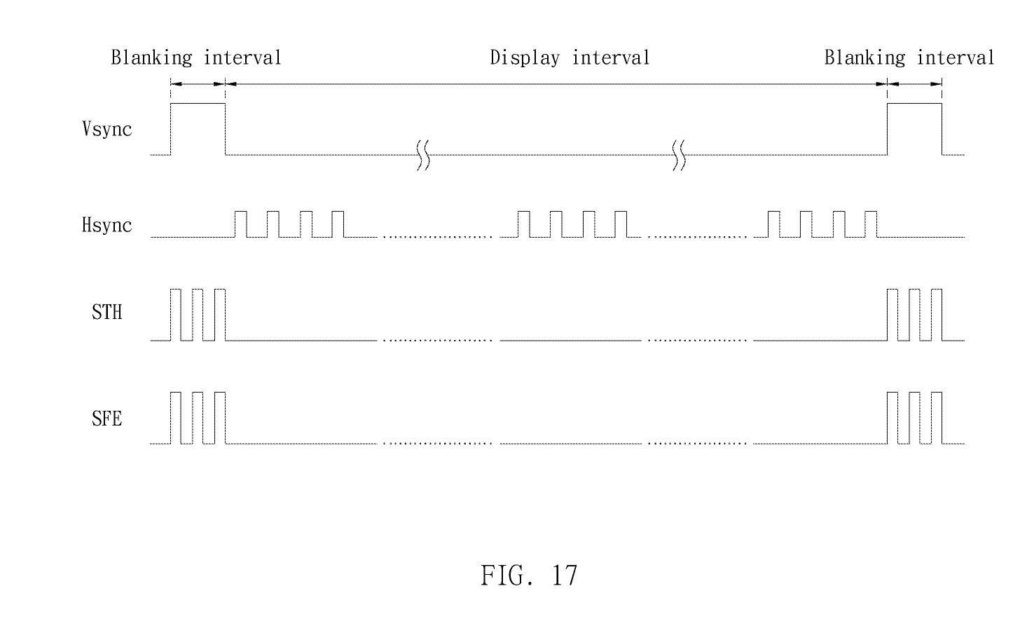

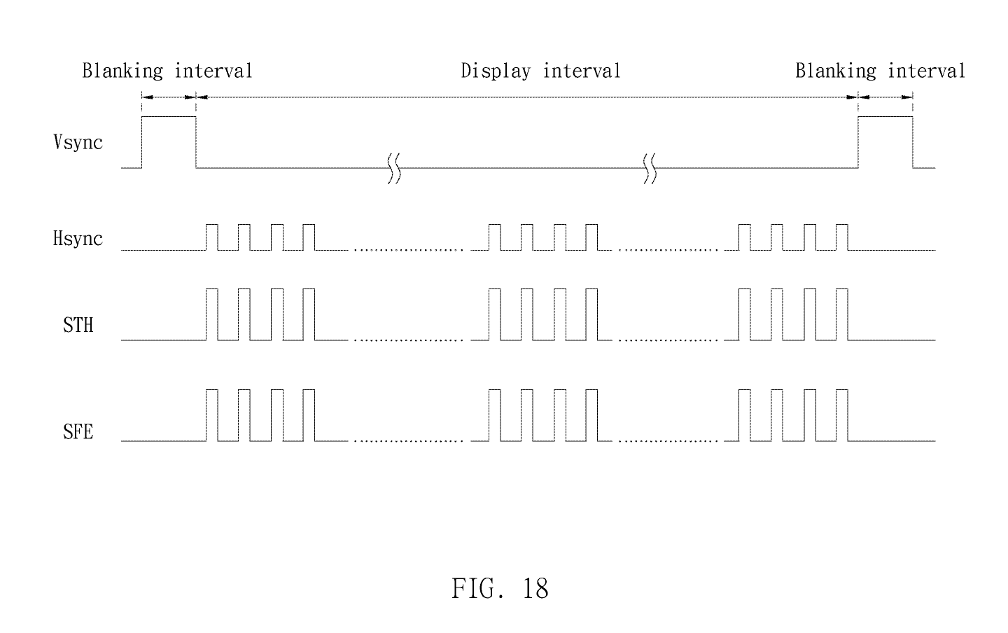

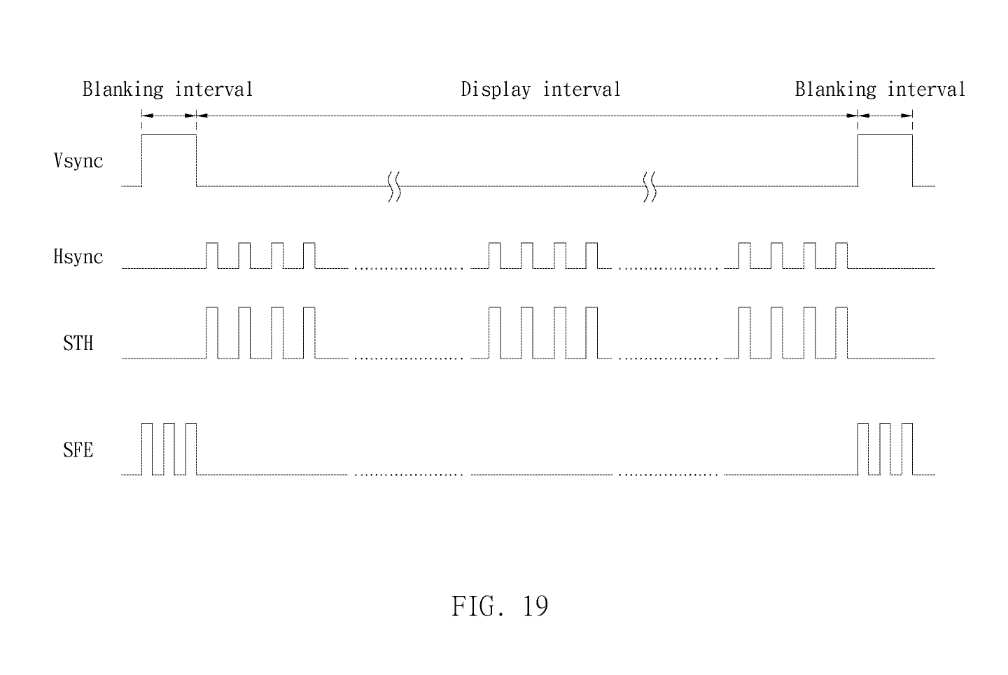

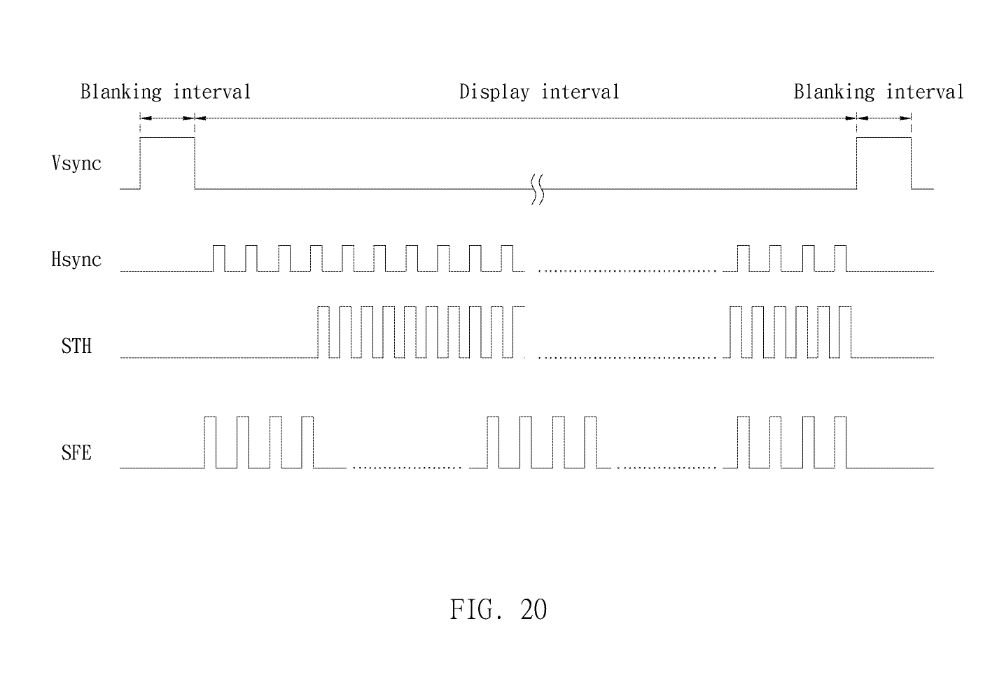

In an embodiment, the touch sensing mode and the force sensing mode of the capacitive force sensing touch panel of the invention can be driven in a time-sharing way with the display mode of the capacitive force sensing touch panel of the invention. As shown in FIG. 16, the capacitive force sensing touch panel performs touch sensing and force sensing during the blanking interval of the display period of the capacitive force sensing touch panel respectively, but not limited to this.

In another embodiment, the touch sensing mode and the force sensing mode of the capacitive force sensing touch panel of the invention can be driven in the same amplitude, the same phase or the same frequency to reduce a driving loading of the touch sensing mode and the force sensing mode without reducing touch and force sensing times.

For example, as shown in FIG. 17, the touch sensing driving signal STH and the force sensing driving signal SFE are both operated during the blanking interval of the vertical synchronous signal Vsync and they both have the same amplitude, the same phase and the same frequency; as shown in FIG. 18, the touch sensing driving signal STH and the force sensing driving signal SFE are both synchronous with the vertical synchronous signal Vsync and they both have the same amplitude, the same phase and the same frequency.

In fact, the touch sensing period of the capacitive force sensing touch panel can at least partially overlap the display interval of the capacitive force sensing touch panel, as shown in FIG. 18˜FIG. 20. In addition, the force sensing period of the capacitive force sensing touch panel can at least partially overlap the display interval of the capacitive force sensing touch panel, as shown in FIG. 18˜FIG. 20.

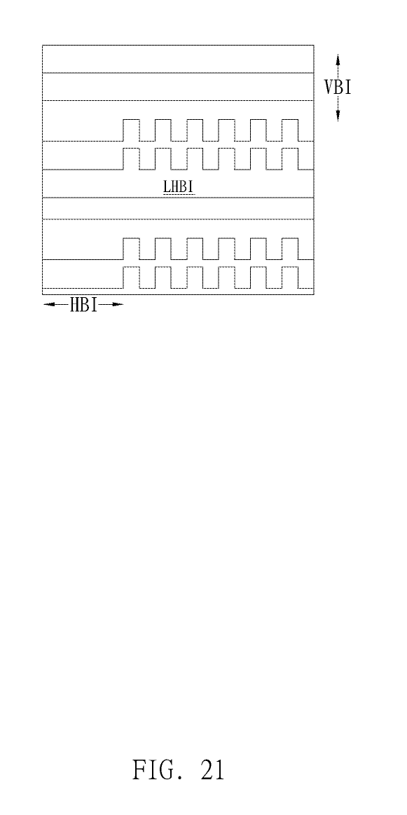

In practical applications, as shown in FIG. 21, the blanking interval can include at least one of the vertical blanking interval (VBI), the horizontal blanking interval (HBI) and the long horizontal blanking interval. Wherein, the long horizontal blanking interval LHBI has a time length equal to or larger than that of the horizontal blanking interval HBI; the long horizontal blanking interval LHBI is obtained by redistributing a plurality of the horizontal blanking interval HBI or the long horizontal blanking interval LHBI includes the vertical blanking interval VBI, but not limited to this.

Compared to the prior art, the capacitive force sensing touch panel of the invention has the following advantages and effects:

(1) Although touch sensing and force sensing both use capacitance variation as judgment basis, the invention uses a relative upper electrode to avoid the effects caused by the change of finger pressing area to maintain the accurate sensed capacitance during the force sensing period.

(2) The capacitive force sensing touch panel of the invention can be applied to in-cell touch panel structure to achieve the effects of thinner and lighter.

(3) Touch sensing and force sensing of the capacitive force sensing touch panel of the invention can be driven in a time-sharing way and operated during the blanking interval of the display period to avoid the noise interference of the liquid crystal module.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A capacitive force sensing touch panel, comprising:
a plurality of pixels, a laminated structure of each pixel comprising:
a first substrate;
a TFT layer disposed above the first substrate;
a first conductive layer disposed above the TFT layer;
a second conductive layer disposed above the first conductive layer;
a third conductive layer corresponding to the second conductive layer and disposed above the second conductive layer; and
a second substrate disposed above the third conductive layer.

2. The capacitive force sensing touch panel of claim 1, wherein the capacitive force sensing touch panel comprises an in-cell touch panel structure.

3. The capacitive force sensing touch panel of claim 1, wherein the laminated structure further comprises:
a common electrode electrically connected to the first conductive layer and divided to form at least one touch electrode through disconnection or electrical connection.

4. The capacitive force sensing touch panel of claim 3, wherein the common electrode is disposed between the TFT layer and the first conductive layer; the first conductive layer and the common electrode are electrically connected through a via.

5. The capacitive force sensing touch panel of claim 3, wherein the common electrode is disposed between the first conductive layer and the second conductive layer; the first conductive layer and the common electrode are electrically connected through a via.

6. The capacitive force sensing touch panel of claim 3, wherein during a touch sensing period, the first conductive is driven as a touch electrode to perform a node self-capacitive touch sensing.

7. The capacitive force sensing touch panel of claim 1, wherein the entire second conductive layer is configured as a force sensing electrode; during a force sensing period, the force sensing electrode receives a force sensing signal and senses a capacitance variation between the third conductive layer and the second conductive layer caused by a change of a distance between the third conductive layer and the second conductive layer; during a touch sensing period, the force sensing electrode receives a floating level.

8. The capacitive force sensing touch panel of claim 1, wherein a part of the second conductive layer is configured as a force sensing electrode, and at least a part of the other part of the second conductive layer is configured as a dummy electrode; during a force sensing period, the force sensing electrode receives a force sensing signal and senses a capacitance variation between the third conductive layer and the second conductive layer caused by a change of a distance between the third conductive layer and the second conductive layer and the dummy electrode receives a floating level; during a touch sensing period, the force sensing electrode and the dummy electrode both receive the floating level.

9. The capacitive force sensing touch panel of claim 1, wherein a part of the second conductive layer is configured as a force sensing electrode, and at least a part of the other part of the second conductive layer is configured as touch electrode traces; during a force sensing period, the force sensing electrode receives a force sensing signal and senses a capacitance variation between the third conductive layer and the second conductive layer caused by a change of a distance between the third conductive layer and the second conductive layer and the dummy electrode receives a floating level; during a touch sensing period, the force sensing electrode receives a floating level.

10. The capacitive force sensing touch panel of claim 1, wherein the third conductive layer disposed above the second conductive layer is formed by an arbitrary conductive layer and maintained at a fixed voltage, when the laminated structure is pressed by a force, the third conductive layer is used as a shielding electrode of the second conductive layer; the fixed voltage is a reference voltage or ground.

11. The capacitive force sensing touch panel of claim 1, wherein the second conductive layer has a mesh type and the second conductive layer is divided to form at least one force sensing electrode through disconnection or electrical connection.

12. The capacitive force sensing touch panel of claim 11, wherein the at least one force sensing electrode is electrically connected to form a force sensing electrode set depending on layout and operational requirements.

13. The capacitive force sensing touch panel of claim 1, wherein a touch sensing mode and a force sensing mode of the capacitive force sensing touch panel are driven in a time-sharing way with a display mode of the capacitive force sensing touch panel; the capacitive force sensing touch panel is operated in the touch sensing mode during a blanking interval of a display period and the first conductive layer is driven as a touch electrode.

14. The capacitive force sensing touch panel of claim 13, wherein the blanking interval comprises at least one of a vertical blanking interval (VBI), a horizontal blanking interval (HBI), and a long horizontal blanking interval, the long horizontal blanking interval has a time length equal to or larger than that of the horizontal blanking interval, the long horizontal blanking interval is obtained by redistributing a plurality of the horizontal blanking interval or the long horizontal blanking interval comprises the vertical blanking interval.

15. A capacitive force sensing touch panel, comprising:
a plurality of pixels, a laminated structure of each pixel comprising:
a first substrate;
a TFT layer disposed above the first substrate;
a first conductive layer disposed above the TFT layer;
a second conductive layer corresponding to the first conductive layer and disposed above the first conductive layer; and
a second substrate disposed above the second conductive layer.

16. The capacitive force sensing touch panel of claim 15, wherein the capacitive force sensing touch panel comprises an in-cell touch panel structure.

17. The capacitive force sensing touch panel of claim 15, wherein the first conductive layer has a mesh type or a strip type.

18. The capacitive force sensing touch panel of claim 15, wherein the laminated structure further comprises:
a common electrode electrically connected to the first conductive layer and divided to form at least one touch electrode through disconnection or electrical connection.

19. The capacitive force sensing touch panel of claim 18, wherein the common electrode is disposed between the TFT layer and the first conductive layer; the first conductive layer and the common electrode are electrically connected through a via.

20. The capacitive force sensing touch panel of claim 18, wherein the common electrode is disposed between the first conductive layer and the second conductive layer; the first conductive layer and the common electrode are electrically connected through a via.

21. The capacitive force sensing touch panel of claim 18, wherein at least one force sensing electrode and force sensing electrode traces are formed by the first conductive layer in a region out of touch electrode traces.

22. The capacitive force sensing touch panel of claim 21, wherein at least one dummy electrode is formed by the first conductive layer in a region out of the touch electrode traces and the force sensing electrode traces.

23. The capacitive force sensing touch panel of claim 22, wherein the at least one dummy electrode is not electrically connected with the at least one touch electrode or the at least one force sensing electrode to maintain a visibility of the capacitive force sensing touch panel and the at least one dummy electrode receives a floating level.

24. The capacitive force sensing touch panel of claim 21, wherein the common electrode is not disposed above the at least one force sensing electrode to avoid shielding an electrical field of force sensing.

25. The capacitive force sensing touch panel of claim 20, wherein the at least one force sensing electrode and the at least one touch electrode are at least partially overlapped.

26. The capacitive force sensing touch panel of claim 15, wherein a touch sensing mode and a force sensing mode of the capacitive force sensing touch panel are driven in a time-sharing way with a display mode of the capacitive force sensing touch panel; the capacitive force sensing touch panel is operated in the touch sensing mode during a blanking interval of a display period.

27. The capacitive force sensing touch panel of claim 26, wherein the blanking interval comprises at least one of a vertical blanking interval (VBI), a horizontal blanking interval (HBI), and a long horizontal blanking interval, the long horizontal blanking interval has a time length equal to or larger than that of the horizontal blanking interval, the long horizontal blanking interval is obtained by redistributing a plurality of the horizontal blanking interval or the long horizontal blanking interval comprises the vertical blanking interval.

28. The capacitive force sensing touch panel of claim 21, wherein during a touch sensing period, the at least one force sensing electrode is maintained at a fixed voltage which is a reference voltage or ground.

29. The capacitive force sensing touch panel of claim 18, wherein during a force sensing period, the at least one touch electrode is maintained at a fixed voltage which is a reference voltage or ground.

30. The capacitive force sensing touch panel of claim 15, wherein a touch sensing mode and a force sensing mode of the capacitive force sensing touch panel are driven in the same amplitude, the same phase or the same frequency to reduce a driving loading of the touch sensing mode and the force sensing mode without reducing touch and force sensing times.

31. The capacitive force sensing touch panel of claim 15, wherein a touch sensing period and a display period of the capacitive force sensing touch panel are at least partially overlapped.

32. The capacitive force sensing touch panel of claim 15, wherein a force sensing period and a display period of the capacitive force sensing touch panel are at least partially overlapped.
